(19) United States
(12) Patent Application Publication
(10) Pub. No.: US 2002/0129132 A1
(43) Pub. Date: Sep. 12, 2002

(54) Network management apparatus, network communication apparatus, network communication program, network communication method and computer network system

(76) Inventor: Takayuki Sato, Tokyo (JP)

Correspondence Address: RYUKA, 1-24-12 SHINJUKU, SIXTH FLOOR, TOSHIN BUILDING, SHINJUKU-KU, TOKYO, 160-0022, JP

(21) Appl. No.: 09/681,725

(22) Filed: May 29, 2001

(30) Foreign Application Priority Data
Mar. 9, 2001 (JP) 2001-66662

(51) Int. Cl. G06F 15/173; G06F 15/16

(52) U.S. Cl. 709/223; 709/203

(57) ABSTRACT

A network communication apparatus includes: a communication controlling memory operable to store setting information of the network communication apparatus; a communication controller operable to control communication by accessing the setting information stored in the communication controlling memory by using a physical address; a file-name sending unit operable to send a predetermined file name when a request for the file name is received; and a setting information sending unit operable to send the setting information stored in the communication controlling memory when the sent file name is specified to request a file having the sent file name.

CROSS REFERENCE TO RELATED APPLICATIONS

This patent application claims priority based on a Japanese patent application, 2001-66662 filed on Mar. 9, 2001, the contents of which are incorporated herein by reference.

### BACKGROUND OF INVENTION

1. Field of the Invention

The present invention relates to a network management apparatus, a network communication apparatus, a network communication program, a network communication method and a computer network system. In particular, the present invention relates to a network management apparatus, a network communication apparatus, a network communication program, a network communication method and a computer network system for allowing a network administrator to easily perform remote management of setting information of an apparatus connected to a network.

2. Description of the Related Art

A conventional network management apparatus performs various settings in a network communication apparatus via a network by using TLENET, SNMP (Simple Network Management Protocol), TFTP (Trivial File Transfer Protocol) or the like. The conventional network management apparatus also performs initial setting of an apparatus to be managed by using an initial setting protocol such as BOOTP (Bootstrap Protocol).

Moreover, Japanese Patent Application Laying-Open No. 2000-165407, published on Jun. 16, 2000, discloses a network management system in which setting of a network apparatus is performed by using TFTP.

In the above-mentioned conventional network management apparatuses, however, the settings are managed by using a plurality of applications corresponding to a plurality of protocols, respectively. Thus, operations in the applications respectively corresponding to the protocols mentioned above that are performed by the network administrator are complicated.

### SUMMARY OF INVENTION

Therefore, it is an object of the present invention to provide a network management apparatus, a network communication apparatus, a network communication program, a network communication method and a computer network system, which are capable of overcoming the above drawbacks accompanying the conventional art. The above and other objects can be achieved by combinations described in the independent claims. The dependent claims define further advantageous and exemplary combinations of the present invention.

According to the first aspect of the present invention, a network management apparatus for managing setting information of a network communication apparatus connected to a network, comprises: a setting information receiving unit operable to receive the setting information of the network communication apparatus from the network communication apparatus; a storing unit operable to store the received setting information as a file and to store identifying information of the network communication having the setting information as a property of the file, the property being capable of being accessed without opening the file; and a setting information sending unit operable to send the file to the network communication apparatus identified by the identifying information so as to change the setting information of the network communication apparatus, when the file is read from the storing unit to be stored in the network communication apparatus.

When the file is read from the storing unit to be stored in a further network communication apparatus connected to the network, the setting information sending unit may send the read file to the further network communication apparatus so as to change setting information of the further network communication apparatus.

According to the second aspect of the present invention, a network communication apparatus comprises: a communication controlling memory operable to store at least one of a program to be used for controlling communication performed by the network communication apparatus and setting information of the communication to be read in accordance with the program; a communication controller operable to control communication by accessing at least one of the program and the setting information stored in the communication controlling memory by using a physical address in the communication controlling memory; a file-name sending unit operable to send a predetermined file name when a request for a file name is received; and a setting information sending unit operable to send at least one of the program and the setting information stored in the communication controlling memory, when the sent file name is specified to request a file having the sent file name.

The communication controlling memory may be a register provided in a communication LSI for controlling communication performed by the network communication apparatus.

The communication controlling memory may store the setting information in the form of a table.

When the sent file name is specified to request a file having the sent file name, the setting information sending unit may read the setting information from the communication controlling memory and send the read setting information after inserting at least a code for line feed into the read setting information.

When the sent file name is specified to request a file having the sent file name, the setting information sending unit may read the setting information from the communication controlling memory and send the read setting information after converting the read setting information into text data.

The network communication apparatus may further include a text memory operable to store text data specifying the type of contents of the setting information in such a manner that the type corresponds to the setting information, wherein the setting information sending unit reads the text data and the setting information from the text memory and the communication controlling memory, respectively, and sends the text data and the setting information.

The file-name sending unit may send the file name when a LIST command or an NLST command in the FTP (File Transfer Protocol) is received.

The setting information sending unit may send the setting information when a GET command or an RETR command in the FTP is received.

The network communication apparatus may further include: a setting information receiving unit operable to receive contents of a file having a specified file name; and a setting information updating unit operable to change the setting information stored in the communication controlling memory based on the contents of the file received by the setting information receiving unit.

The setting information updating unit may change the setting information stored in the communication controlling memory when a file name of the file received by the setting information receiving unit coincides with the file name sent by the file-name sending unit.

The setting information updating unit may change the setting information stored in the communication controlling memory when a PUT command or an STOR command is in the FTP.

According to the third aspect of the present invention, a network communication program of a network communication apparatus, comprises: a storing module operable to store at least one of a program to be used for controlling communication performed by the network communication apparatus and setting information of the communication to be read in accordance with the communication; a communication controlling module operable to control communication by accessing at least one of the program and the setting information stored in a communication controlling memory of the network communication apparatus by using a physical address in the communication controlling memory; a file-name sending module operable to send a predetermined file name when a request for a file name is received; and a setting information sending module operable to send at least one of the program and the setting information stored in the communication controlling memory when the sent file name is specified to request a file having the sent file name.

According to the fourth aspect of the present invention, a network communication method in a network communication apparatus, comprises: storing at least one of a program to be used for controlling communication by the network communication apparatus or setting information of the communication to be read in accordance with the program in a communication controlling memory of the network communication apparatus; controlling communication by accessing at least one of the program and the setting information in the communication controlling memory by using a physical address in the communication controlling memory; sending a predetermined file name when a file name request for a file name is received; and sending at least one of the program and the setting information in the communication controlling memory when the sent file name is specified to request a file having the sent file name.

The setting information may be stored in a register provided in a communication LSI serving as the communication controlling memory while being stored. Moreover, while being stored, the setting information may be stored in the form of a table.

While sending the setting information, the setting information may be read from the communication controlling memory and is sent after being formatted by insertion of at least a code for line feed. Moreover, while sending the setting information, the setting information may be sent after being converted into text data.

While being stored, text data specifying a type of setting information may be further stored so as to correspond with the setting information, while sending the setting information the text data and the setting information respectively read from the text memory and the communication controlling memory may be sent when the file is requested.

While sending the file name, the file name may be sent when a LIST command or an NLST command in the FTP receives the file name.

While sending the setting information, the setting information may be sent when a GET command or an RETR command in the FTP is received.

The network communication method may further include: receiving contents of a file having a file name specified; and changing the setting information stored in the communication controlling memory of the network communication apparatus based on the contents of the file received while receiving the setting information.

While changing the setting information, the setting information may be changed when the file name of the file received while receiving the setting information coincides with the file name sent when sending the file name.

While changing the setting information, the setting information stored in the communication controlling memory of the network communication apparatus may be changed when a PUT command or a STOR command in the FTP is received.

According to the fifth aspect of the present invention, a computer network system comprises: a network communication apparatus operable to perform communication in a network; and a network management apparatus operable to manage setting information of the network communication apparatus. In the computer network system, the network communication apparatus includes: a communication controlling memory operable to store at least one of a program to be used for controlling the communication and setting information of the communication to be read in accordance with the program; a communication controller operable to control communication by accessing at least one of the program and the setting information in the communication controlling memory by using a physical address in the communication controlling memory; a file-name sending unit operable to send a predetermined file name when a request for a file name is received from the network management apparatus; a communication-side setting information sending unit operable to send at least one of the program and the setting information in the communication controlling memory of the network communication apparatus to the network management apparatus, when the sent file name is specified in the network management apparatus to request a file having the file name.

The communication controlling memory may be a register provided in a communication LSI for controlling the communication.

The communication controlling memory may store the setting information in the form of a table.

The communication-side setting information sending unit may read the setting information from the communication controlling memory and send the read setting information that has been formatted by insertion of at least a code for line feed.

The communication-side setting information sending unit may send the setting information after converting the setting information into text data.

The network communication apparatus may further include a text memory operable to store text data specifying a type of contents of the setting information so as to correspond to the setting information. In this case, the communication-side setting information sending unit sends the network management apparatus the text data and the setting information respectively read from the text memory and the communication controlling memory, when the file is requested.

The file-name sending unit may send the file name when a LIST command or an NLST command in the FTP is received from the network management apparatus.

The communication-side setting information may send the setting information when a GET command or an RETR command in the FTP is received from the network management apparatus.

The network communication apparatus may further include: a communication-side setting information receiving unit operable to receive contents of a file having a specified file name; and a setting information updating unit operable to change the setting information stored in the communication controlling memory based on the contents of the file received by the communication-side setting information receiving unit.

The setting information updating unit may change the setting information stored in the communication controlling memory when the file name of the file received by the communication-side setting information receiving unit coincides with the file name sent by the file-name sending unit.

The setting information updating unit may change the setting information stored in the communication controlling memory when a PUT command or a STOR command in the FTP is received from the network management apparatus.

The network management apparatus may include: a file-name receiving unit operable to receive a file name determined in advance in the network communication apparatus from the network communication apparatus by specifying the network communication apparatus; a management-side setting information receiving unit operable to receive the setting information of the network communication apparatus from the network communication apparatus by specifying the received file name; and a display unit operable to display the received setting information.

The management-side setting information receiving unit may format the received setting information by inserting at least a code for line feed into the setting information. In this case, the display unit displays the formatted setting information.

The management-side setting information receiving unit may convert the received setting information into text data. In this case, the display unit displays the setting information after being converted into text data.

The network management apparatus may further include a text memory operable to store text data specifying a type of contents of the setting information to correspond with the setting information. In this case, the display unit displays the text data read from the text memory and the setting information received by the management-side setting information receiving unit in such a manner that the text data corresponds with the setting information.

The network management apparatus may further include: a management-side setting information changing unit operable to change the received setting information; and a management-side setting information sending unit operable to send the network communication apparatus the setting information that has been changed so as to change setting information of the network communication apparatus.

The management-side setting information sending unit may send the setting information received from the network communication apparatus to a further network communication apparatus to sent setting information of the further network communication apparatus.

The summary of the invention does not necessarily describe all necessary features of the present invention. The present invention may also be a sub-combination of the features described above. The above and other features and advantages of the present invention will become more apparent from the following description of the embodiments taken in conjunction with the accompanying drawings.

### BRIEF DESCRIPTION OF DRAWINGS

FIG. 1 schematically shows a structure of a computer network system according to an embodiment of the present invention.

FIG. 2 shows a structure of a network communication apparatus 10.

FIG. 3 schematically shows a structure of a network management apparatus 14.

FIG. 4 is a chart showing a sequence of communication between the network communication apparatus 10 and the network management apparatus 14.

FIGS. 5A and 5B show exemplary display screens created by a display unit 202 of the network management apparatus 14.

FIG. 6 shows another exemplary display screen created by the display unit 202 of the network management apparatus 14.

FIG. 7 shows an exemplary hardware configuration of the network communication apparatus 10.

### DETAILED DESCRIPTION

The invention will now be described based on the preferred embodiments, which do not intend to limit the scope of the present invention, but exemplify the invention. All of the features and the combinations thereof described in the embodiment are not necessarily essential to the invention.

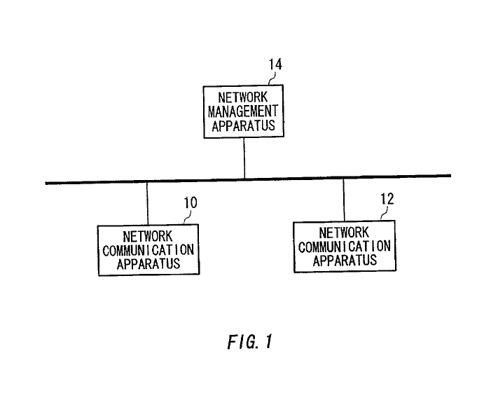

FIG. 1 schematically shows a structure of a computer network system according to an embodiment of the present invention. The computer network system of the present embodiment includes network communication apparatuses 10 and 12, each of which can perform communication in a network, and a network management apparatus 14 which manages setting information of each of the network communication apparatuses 10 and 12. The network communication apparatuses 10 and 12 are interconnecting units in the network such as a router or a switching hub, for example. The network communication apparatuses 10 and 12 may have the same structures. In the following description, the arrangement and operation of the computer network system are described referring to the network communication apparatus 10.

The network management apparatus 14 performs remote management of the setting information of the network communication apparatus 10 via the network. For example, the network management apparatus 14 receives the setting information of the network communication apparatus 10 from the network communication apparatus 10 and changes the received setting information. The network management apparatus 14 then sends the setting information of the network communication apparatus 10 after being changed to the network communication apparatus 10, thereby changing the setting information of the network communication apparatus 10.

The network management apparatus 14 may change the setting information of the network communication apparatus 12 by sending the network communication apparatus 12 the setting information received from the network communication apparatus 10. Moreover, the network management apparatus 14 may create setting information of a particular network communication apparatus in advance and may perform setting in a new network communication apparatus by sending the setting information that has already been created in advance for the particular network communication apparatus to the new network communication apparatus when the new communication apparatus is added in the network. In addition, the network management apparatus 14 may store the setting information of the network communication apparatus 10 received therefrom as backup data.

The network management apparatus 14 may receive a program to be used for control of communication from the network communication apparatus 10. Moreover, the network management apparatus 14 may install the program received from the network communication apparatus 10 into another network communication apparatus by sending the received program to the other network communication apparatus.

The network communication apparatus 10 sends the setting information thereof to the network management apparatus 14 based on a request from the network management apparatus 14. The network communication apparatus 10 receives the setting information from the network management apparatus 14 and changes the setting information of the network communication apparatus 10 based on the received setting information, thereby changing the setting of the network communication apparatus 10. For example, the network communication apparatus 10 operates in response to commands in FTP sent from the network management apparatus 14. Thus, the network management apparatus 14 can handle the setting information of the network communication apparatus 10 in the same manner as that in which the network management apparatus 14 handles data having a file structure. In other words, the network administrator can perform various operations including a copy operation, a saving operation, an edit operation, as well as for the setting information of the network communication apparatus 10 like operations for a file in a personal computer.

The network communication apparatus 10 may send the program to be used for the control of the communication to the network management apparatus 14. Moreover, the network communication apparatus 10 may be provided with the program for the communication control to be installed therein by receiving the program from the network management apparatus 14. In addition, the network communication apparatus 10 may divide the program for the communication control into a plurality of units so as to allow the sending operation and/or the receiving operation of the program to be performed for each unit. In this case, the network communication apparatus 10 can update the program on a function basis without restarting the system.

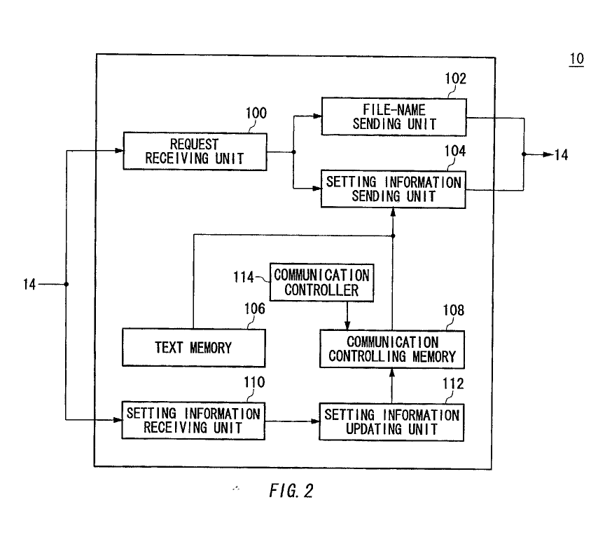

FIG. 2 is a block diagram schematically showing a structure of the network communication apparatus 10. The network communication apparatus 10 includes a communication controlling memory 108 for storing the program for the communication control or setting information for communication that can be read in accordance with the program for the communication control, a text memory 106 for storing text data specifying a type of contents of the setting information of the network communication apparatus 10, a communication controller 114 for controlling communication by accessing the program or the setting information stored in the communication controlling memory 108 based on a physical address in the communication controlling memory 108, a request receiving unit 100 for receiving a request from the network management apparatus 14, a file-name sending unit 102 for sending a file name to the network management apparatus 14, a setting information sending unit 104 for sending the program or the setting information to the network management apparatus 14, a setting information receiving unit 110 for receiving the contents of a file from the network management apparatus 114, and a setting information updating unit 112 for changing the setting information stored in the communication controlling memory 108. The communication controlling memory 108 may be a ROM or RAM provided in the network communication apparatus 10 or a register provided within a communication LSI for controlling communication performed by the network communication apparatus 10. In addition, it is preferable that the communication controlling memory 108 stores the setting information of the network communication apparatus 10 in the form of a table.

The request receiving unit 100 receives a request for a file name and a request for a file that have been sent from the network management apparatus 14. In a case where the request receiving unit 100 receives the file name request, the file-name sending unit 102 sends a predetermined file name to the network management apparatus 14. In a case where the request receiving unit 100 receives a request for the setting information, the setting information sending unit 104 sends the network management apparatus 14 the setting information stored in the communication controlling memory 108 and the text data specifying the type of contents of the setting information stored in the text memory 106. In this case, the setting information sending unit 104 reads the setting information from the communication controlling memory 108 by accessing the communication controlling memory 108 using the physical address. In addition, the setting information sending unit 104 formats the read setting information by inserting at least a code for line feed into the read setting information, so as to create text data and send it.

In an alternative embodiment, the setting information sending unit 104 may send the network management apparatus 14 the setting information read from the communication controlling memory 108 as binary data. In this case, the network management apparatus 14 formats the setting information received as binary data so as to create text data.

The setting information receiving unit 110 receives the contents of the file having the file name specified by the network management apparatus 14. The setting information updating unit 112 changes the setting information stored in the communication controlling memory 108 based on the contents of the file received by the setting information receiving unit 110. In this case, the setting information updating unit 112 changes the setting information stored in the communication controlling memory 108 if the file name sent by the file-name sending unit 102 coincides with the file name received by the setting information receiving unit 110.

As described above, the network management apparatus 14 of the present embodiment can handle the setting information of the network communication apparatus 10 in the same manner as that in which the network management apparatus 14 handles data having a file structure. Thus, the network administrator can easily perform various operations including a copy operation, a saving operation, an edit operation and the like for the setting information of the network communication apparatus 10.

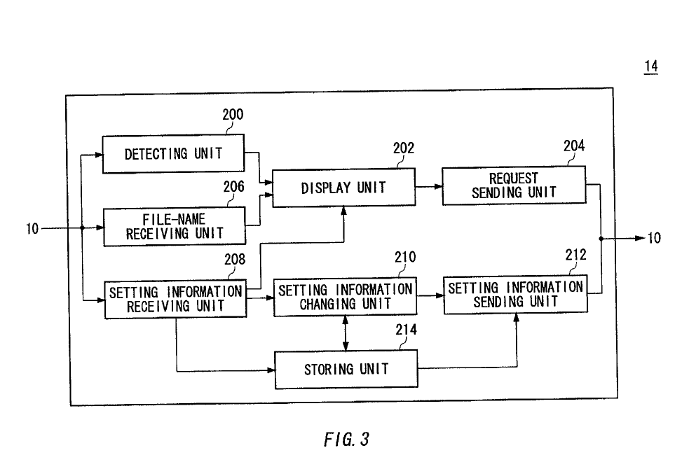

FIG. 3 is a block diagram schematically showing a structure of the network management apparatus 14. The network management apparatus 14 includes a detecting unit 200 for detecting a network communication apparatus connected to the network, a request sending unit 204 for sending a request for a file name and a request for a file to the network communication apparatus 10, a file-name receiving unit 206 for receiving the file name from the network communication apparatus 10, a setting information receiving unit 208 for receiving the setting information from the network communication apparatus 10, a setting information changing unit 210 for changing the setting information, a setting information receiving unit 212 for sending the setting information to the network communication apparatus 10, a storing unit 214 for storing the setting information, and a display unit 202 for displaying the received information.

The display unit 202 displays an image or an icon representing the network communication apparatus 10 detected by the detecting unit 200. When the network administrator specifies the image displayed by the display unit 202 corresponding to the network communication apparatus 10, the request sending unit 204 sends the network communication apparatus 10 the file name request. The display unit 202 also displays the file name received by the file-name receiving unit 206. When the file name displayed by the display unit 202 is specified, the request sending unit 204 sends the network communication apparatus 10 the request for the file having the specified file name.

The setting information receiving unit 208 receives the setting information sent from the network communication apparatus 10 in response to the request from the request sending unit 204. The setting information receiving unit 208 receives the setting information of the network communication apparatus as text data. The display unit 202 then displays the received setting information in the form of text data. The display unit 202 may display the setting information by using a GUI (Graphical User Interface). In an alternative embodiment, the setting information receiving unit 208 may receive the setting information of the network communication apparatus 10 as binary data. In this case, the setting information receiving unit 208 formats the received binary data, i.e., the received setting information, by inserting at least a code for line feed into the binary data so as to convert the binary data to text data. The display unit 202 then displays the setting information that has been converted into text data.

The setting information changing unit 210 changes the setting information received by the setting information receiving unit 208. The storing unit 214 stores the setting information received by the setting information receiving unit 208. The storing unit 214 may store the setting information after being changed by the setting information changing unit 210. The setting information sending unit 212 sends the network communication apparatus 10 the setting information changed by the setting information changing unit 210 or the setting information stored in the storing unit 214 in order to change the setting in the network communication apparatus 10.

The storing unit 214 may store the setting information of the network communication apparatus 10 as backup data. In this case, when something is wrong with the network communication apparatus 10 and therefore the setting information of the network communication apparatus 10 is lost, for example, the setting information sending unit 212 of the network management apparatus 14 can send the network communication apparatus 10 the setting information stored as backup data in the storing unit 214 so as to set the same setting information as that before the failure occurred in the network communication apparatus 10 in the network communication apparatus 10.

The storing unit 214 may store the setting information as a file. Moreover, the storing unit 214 may store identifying information of the network communication apparatus having the setting information stored as the file as a property that is information of the file that can be read and written without opening the file. In addition, in a case where the file was read from the storing unit 214 and was saved in the network communication apparatus, the setting information sending unit 212 of the network management apparatus 14 may send the file to the network communication apparatus identified by the identifying information saved as property in order to change the setting information of that network communication apparatus. Furthermore, the storing unit 214 may store information regarding security such as an encryption method or a password, information of the protocol to be used, or the like, as property of the setting information.

The network management apparatus 14 may further include a text memory for storing text data that specifies the contents of the setting information so that the text data corresponds to the associated setting information. In this case, the display unit 202 displays the text data read from the text memory and the setting information received from the network communication apparatus 10 so that the text data and the associated setting information correspond to each other.

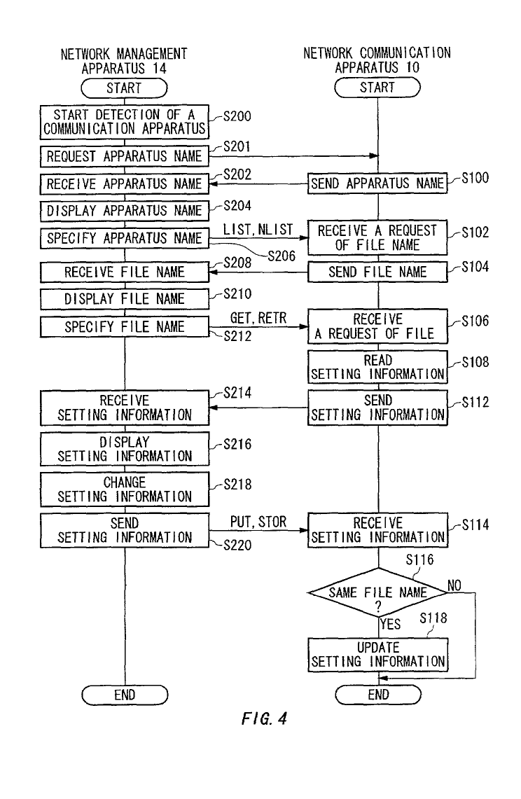

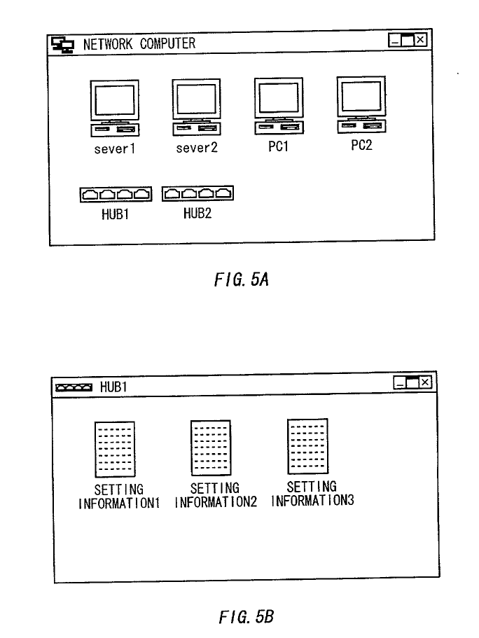

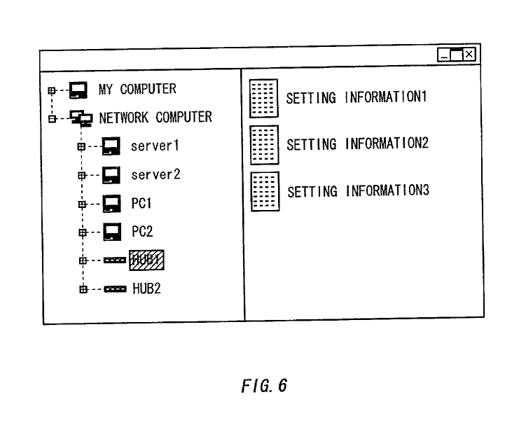

FIG. 4 shows a sequence of communication between the network communication apparatus 10 and the network management apparatus 14. FIGS. 5A and 5B show exemplary display screens created by the display unit 202. FIG. 6 shows another exemplary display screen created by the display unit 202. In the following description, the operations of the network communication apparatus 10 and the network management apparatus 14 are described referring to FIGS. 4, 5A, 5B and 6.

In the network management apparatus 14, detection of a network communication apparatus is started (Step S200). The detecting unit 200 of the network management apparatus 14 sends the network communication apparatus connected to the network a request for an apparatus name (Step S201). The network communication apparatus 10 then sends an apparatus name and an apparatus type thereof to the network management apparatus 14 in response to the request from the network management apparatus 14 (Step S100). The detecting unit 200 of the network management apparatus 14 then receives the apparatus names and the apparatus types of the network communication apparatus 10 and another communication apparatus that were sent from these network communication apparatuses (Step S202). Then, the display unit 202 of the network management apparatus 14 displays the received apparatus names of the network communication apparatuses (Step S204).

FIG. 5A shows the exemplary display screen created by the display unit 202 in Step S204. The display unit 202 displays the apparatus names received by the detecting unit 200 in such a manner that the apparatus names correspond to icons representing the network communication apparatuses such as a personal computer, a switching hub and the like that sent the apparatus names, respectively, as shown in FIG. 5A. In the network management apparatus 14, the icons of the network communication apparatuses such as the personal computer, the switching hub and the like are stored in advance so as to correspond to the apparatus types of the network communication apparatus, respectively, while the display unit 202 displays the received apparatus names received by the detecting unit 200 and the icons associated with the apparatus types respectively corresponding to the apparatus names in such a manner that the apparatus names and the icons correspond to each other. The display unit 202 may display the apparatus names received by the detecting unit 200 to form a tree structure, as shown in FIG. 6.

The network management apparatus 14 may further include a storing unit that can store apparatus names to be displayed by the display unit 202 in such a manner that the apparatus names respectively correspond to host names, IP addresses or the like of the network communication apparatuses connected to the network. In this case, the network management apparatus 14 can receive the host name, IP address or the like from the network communication apparatus and the display unit 202 can display the apparatus name stored in the above-mentioned storing unit of the network management apparatus 14 to correspond to the associated host name, IP address or the like that was received. The network management apparatus 14 sets the apparatus name that is associated with the host name, IP address or the like based on an input by the network administrator.

Next, when the network administrator specifies the apparatus name of the network communication apparatus 10 on the display screen shown in FIG. 5A (Step S206), the request sending unit 204 of the network management apparatus 14 sends the network communication apparatus 10 a request for a file name of the setting information, for example, a LIST command or an NLST command in the FTP.

In the network communication apparatus 10, the request receiving unit 100 receives the file name request (the LIST command or the NLST command) from the network management apparatus 14 (Step S102). Then, in a case where the request receiving unit 100 of the network communication apparatus 10 receives the file name request (the LIST command or the NLST command), the file-name sending unit 102 of the network communication unit 10 sends a predetermined file name to the network management apparatus 14 (Step S104). In the network management apparatus 14, the file-name receiving unit 206 receives the file name sent from the network communication apparatus 10 (Step S208). Then, the display unit 202 of the network management apparatus 14 displays the file name received by the file-name receiving unit 206 from the network communication apparatus 10 (Step S210).

FIG. 5B shows the exemplary display screen created by the display unit 202 in Step S210. The display unit 202 displays the received file name together with an icon representing text data or the like. The display unit 202 may display the setting information while classifying the setting information into a plurality of categories, for example, including VLAN information, QoS (line quality) information, communication-method information, security information, firewall information, port information, and communication-parameter information. By performing such classification, in a case where the setting information regarding the security is set to be the same in all of a plurality of network communication apparatuses, for example, the setting information regarding the security can be updated in all the network communication apparatuses by using the setting information regarding the security of one of the network communication apparatuses. Furthermore, the display unit 202 may display the apparatus names displayed in Step S202 and the file names displayed in Step S210 simultaneously.

Next, when the network administrator specifies the file name of the network communication apparatus 10 on the display screen shown in FIG. 5B (Step S212), the request sending unit 204 of the network management apparatus 14 sends a request for a file having the specified file name, that is a GET command or a RETE command in the FTP, for example, to the network communication apparatus 10.

In the network communication apparatus 10, the request receiving unit 100 receives the file request (the GET command or the RETR command) from the network management apparatus 14 (Step S106). In a case where the request receiving unit 100 received the file request (the GET command or the RETR command), the setting information sending unit 104 of the network communication apparatus 10 reads out the setting information from the communication controlling memory 108 (Step S108). The setting information sending unit 104 then sends the read setting information to the network management apparatus 14 (Step S112).

In the network management apparatus 14, the setting information receiving unit 208 receives the setting information sent from the network communication apparatus 10 (Step S214). The display unit 202 of the network management apparatus 14 then displays the setting information received by the setting information receiving unit 208 (Step S216). Subsequently, the setting information changing unit 210 changes the setting information received by the setting information receiving unit 208 based on the input by the network administrator (Step S218). Then, the setting information sending unit 212 of the network management apparatus 14 sends the setting information after being changed to the network communication apparatus 10 (Step S220). For example, in the network management apparatus 14, the setting information sending unit 212 sends the setting information, using the PUT command or the STOR command in the FTP.

Then, in the network communication apparatus 10, the setting information receiving unit 110 receives the contents of the file having the file name specified by, for example, the PUT command or the STOR command in the FTP, from the network management apparatus (Step S114). In a case where the setting information receiving unit 110 receives the PUT command or the STOR command in the FTP, the setting information updating unit 112 then determines whether or not the file name sent by the file-name sending unit 102 coincides with the file name received by the setting information receiving unit 110 (Step S116). When it is determined that the file names coincide with each other, the setting information updating unit 112 of the network communication apparatus 10 changes the setting information stored in the communication controlling memory 108 based on the contents of the file received by the setting information receiving unit 110 (Step S118).

As described above, according to the computer network system of the present embodiment, the network communication apparatus 10 performs operations in response to the commands in the FTP. Thus, the network administrator can handle the setting information of the network communication apparatus 10 in the network management apparatus 14 in the same manner as that in which data having a file structure is handled. Accordingly, the network administrator can perform various operations for setting information of the network communication apparatus 10, including a copy operation, a saving operation, an edit operation, and the like.

According to the network communication apparatus 10 of the present embodiment, the setting information is sent/received using the FTP. Thus, security by certification can be enhanced. Moreover, security of the network communication apparatus 10 can be further enhanced by combining encryption, firewall and the like. The enhanced security can allow the network administrator to manage the setting information of the network communication apparatus 10 more safely even in a case where the network administrator performs the management of the setting information through the Internet or WAN (Wide Area Network).

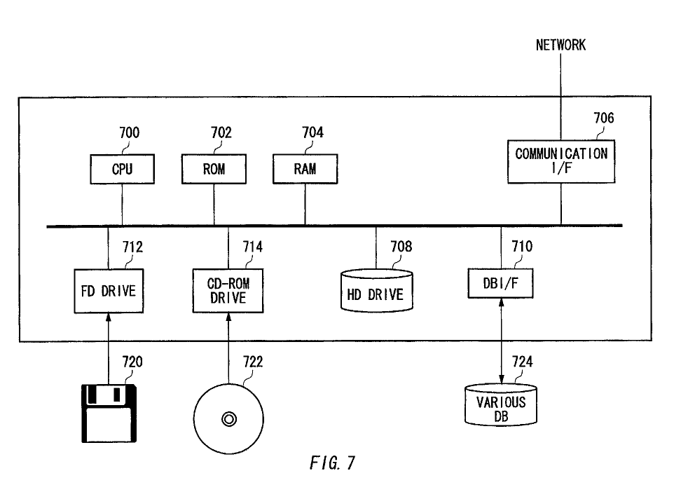

FIG. 7 shows an exemplary hardware configuration of the network monitoring apparatus 10. The network monitoring apparatus 10 includes a CPU 700, a ROM 702, a RAM 704, a communication interface 706, a hard disk drive 708, a database interface 710, a floppy disk drive 712 and a CD-ROM drive 714. The CPU 700 operates based on at least one program stored in the ROM 702 and RAM 704. The communication interface 706 allows communication with another network communication apparatus through the network. The database interface 710 writes data into a database and updates the contents of the database. The hard disk drive 708, that is an example of a storage device, stores setting information and a program for the operation of the CPU 700.

The floppy disk drive 712 reads data or a program from a floppy disk 720 to provide the read data or program to the CPU 700. The CD-ROM drive 714 reads data or a program from a CD-ROM 722 to provide the read data or program to the CPU 700. The communication interface 706 can be connected to the network communication device so as to perform data transmission and data receiving. The database interface 710 can be connected to the various databases 724 so as to perform data transmission and data receiving.

Software executed by the CPU 700 is provided to a user while being stored in a recording medium such as the floppy disk 720 or the CD-ROM 722. The software stored in the recording medium may be compressed or non-compressed. The software is installed from the recording medium into the hard disk drive 708, and is then read into the RAM 704 so that the CPU 700 executes the software.

The software provided while being stored in the recording medium, that is the software to be installed into the hard disk drive 708, functionally includes an input module, a setting module, a receiving module, a comparing module, a display module and a storing module. Operations that are to be executed by the CPU 700 in accordance with instructions of the respective module to the computer are the same as the functions and operations of the corresponding components in the network monitoring apparatus 10 of the present invention, respectively, and therefore the description thereof is omitted.

A part or all of the functions and operations of the network monitoring apparatus 10 according to all the embodiments described in the present application can be stored in the floppy disk 720 or the CD-ROM 722 shown in FIG. 7 as examples of the recording medium.

These programs may be read directly into the RAM from the recording medium, or read into the RAM after being installed into the hard disk drive from the recording medium. Moreover, the above-mentioned programs may be stored in a single recording medium or a plurality of recording media. Furthermore, the programs may be stored while being encoded.

As the recording medium, other than the floppy disk and the CD-ROM, an optical recording medium such as a DVD or a PD, a magneto-optical recording medium such as an MD, a tape-like medium, a magnetic recording medium, or a semiconductor memory such as an IC card or a miniature card can be used. Moreover, a storage device such as a hard disk or a RAM provided in a server system connected to an exclusive communication network or the Internet may be used as the recording medium, so that the program can be provided to the network monitoring apparatus 10 through the communication network or the Internet. Such a recording medium is used only for manufacturing the network monitoring apparatus 10 and it is therefore apparent that manufacturing or selling such a recording medium as business can constitute infringement of the right based on the present application.

As is apparent from the above description, according to the present invention, a network management apparatus, a network communication apparatus, a network communication program, a network communication method and a computer network system each of which allows a network administrator to perform remote management of setting information of an apparatus connected to a network can be easily provided.

Although the present invention has been described by way of exemplary embodiments, it should be understood that those skilled in the art might make many changes and substitutions without departing from the spirit and the scope of the present invention which is defined only by the appended claims.

1. A network management apparatus for managing setting information of a network communication apparatus connected to a network, comprising:
a setting information receiving unit operable to receive said setting information of said network communication apparatus from said network communication apparatus;
a storing unit operable to store said received setting information as a file and to store identifying information of said network communication having said setting information as a property of said file, said property being capable of being accessed without opening said file; and
a setting information sending unit operable to send said file to said network communication apparatus identified by said identifying information so as to change said setting information of said network communication apparatus, when said file is read from said storing unit to be stored in said network communication apparatus.

2. A network management apparatus as claimed in claim 1, wherein, when said file is read from said storing unit to be stored in a further network communication apparatus connected to said network, said setting information sending unit sends said read file to said further network communication apparatus so as to change setting information of said further network communication apparatus.

3. A network communication apparatus comprising:
a communication controlling memory operable to store at least one of a program to be used for controlling communication performed by said network communication apparatus and setting information of said communication to be read in accordance with said program;
a communication controller operable to control said communication by accessing said at least one of said program and said setting information stored in said communication controlling memory by using a physical address in said communication controlling memory;
a file-name sending unit operable to send a predetermined file name when a request for a file name is received; and
a setting information sending unit operable to send said at least one of said program and said setting information stored in said communication controlling memory, when said sent file name is specified to request a file having said sent file name.

4. A network communication apparatus as claimed in claim 3, wherein said communication controlling memory is a register provided in a communication LSI for controlling said communication performed by said network communication apparatus.

5. A network communication apparatus as claimed in claim 3, wherein said communication controlling memory stores said setting information in the form of a table.

6. A network communication apparatus as claimed in claim 4, wherein, when said sent file name is specified to request a file having said sent file name, said setting information sending unit reads said setting information from said communication controlling memory and sends said read setting information after inserting at least a code for line feed into said read setting information.

7. A network communication apparatus as claimed in claim 4, wherein, when said sent file name is specified to request a file having said sent file name, said setting information sending unit reads said setting information from said communication controlling memory and sends said read setting information after converting said read setting information into text data.

8. A network communication apparatus as claimed in claim 3, further comprising a text memory operable to store text data specifying a type of the contents of said setting information in such a manner that said type corresponds to said setting information, wherein
said setting information sending unit reads said text data and said setting information from said text memory and said communication controlling memory, respectively, and sends said text data and said setting information.

9. A network communication apparatus as claimed in claim 3, wherein said file-name sending unit sends said file name when a LIST command or an NLST command in the FTP (File Transfer Protocol) is received.

10. A network communication apparatus as claimed in claim 3, wherein said setting information sending unit sends said setting information when a GET command or an RETR command in the FTP (File Transfer Protocol) is received.

11. A network communication apparatus as claimed in claim 3, further comprising:
a setting information receiving unit operable to receive contents of a file having a specified file name; and
a setting information updating unit operable to change said setting information stored in said communication controlling memory based on said contents of said file received by said setting information receiving unit.

12. A network communication apparatus as claimed in claim 11, wherein said setting information updating unit changes said setting information stored in said communication controlling memory when a file name of said file received by said setting information receiving unit coincides with said file name sent by said file-name sending unit.

13. A network communication apparatus as claimed in claim 12, wherein said setting information updating unit changes said setting information stored in said communication controlling memory when a PUT command or a STOR command in FTP (File Transfer Protocol) is received.

14. A network communication program of a network communication apparatus, comprising:
a storing module operable to store at least one of a program to be used for controlling communication performed by said network communication apparatus and setting information of said communication to be read in accordance with said communication;
a communication controlling module operable to control said communication by accessing said at least one of said program and said setting information stored in a communication controlling memory of said network communication apparatus by using a physical address in said communication controlling memory;
a file-name sending module operable to send a predetermined file name when a request for a file name is received; and
a setting information sending module operable to send said at least one of said program and said setting information stored in said communication controlling memory when said sent file name is specified to request a file having said sent file name.

15. A network communication method in a network communication apparatus, comprising:
storing at least one of a program to be used for controlling communication by said network communication apparatus and setting information of said communication to be read in accordance with said program in a communication controlling memory of said network communication apparatus;
controlling said communication by accessing said at least one of said program and said setting information in said communication controlling memory by using a physical address in said communication controlling memory;
sending a predetermined file name when a file name request for a file name is received; and
sending said at least one of said program and said setting information in said communication controlling memory when said sent file name is specified to request a file having said sent file name.

16. A network communication method as claimed in claim 15, wherein said setting information is stored in a register provided in a communication LSI serving as said communication controlling memory in said storing.

17. A network communication method as claimed in claim 15, wherein, in said storing, said setting information is stored in the form of a table.

18. A network communication method as claimed in claim 16, wherein, in said setting information sending, said setting information is read from said communication controlling memory and is sent after being formatted by insertion of at least a code for line feed.

19. A network communication method as claimed in claim 18, wherein, in said setting information sending, said setting information is sent after being converted into text data.

20. A network communication method as claimed in claim 15, wherein, in said storing, text data specifying a type of said setting information is further stored so as to correspond with said setting information, and in said setting information sending, said text data and said setting information respectively read from said text memory and said communication controlling memory are sent when said file is requested.

21. A network communication method as claimed in claim 15, wherein, in said file name sending, said file name is sent when a LIST command or an NLST command in the FTP (File Transfer Protocol) receives said file name.

22. A network communication method as claimed in claim 15, wherein, in said setting information sending, said setting information is sent when a GET command or an RETR command in the FTP (File Transfer Protocol) is received.

23. A network communication method as claimed in claim 15, further comprising:
receiving contents of a file having a file name specified; and
changing said setting information stored in said communication controlling memory of said network communication apparatus based on said contents of said file received in said setting information receiving.

24. A network communication method as claimed in claim 23, wherein, in said setting information changing, said setting information is changed when said file name of said file received in said setting information receiving coincides with said file name sent in said file name sending.

25. A network communication method as claimed in claim 24, wherein, in said setting information changing, said setting information stored in said communication controlling memory of said network communication apparatus is changed when a PUT command or a STOR command in the FTP (File Transfer Protocol) is received.

26. A computer network system comprising:
a network communication apparatus operable to perform communication in a network; and
a network management apparatus operable to manage setting information of said network communication apparatus, wherein
said network communication apparatus includes:
a communication controlling memory operable to store at least one of a program to be used for controlling said communication and said setting information of said communication to be read in accordance with said program;
a communication controller operable to control said communication by accessing said at least one of said program and said setting information in said communication controlling memory by using a physical address in said communication controlling memory;
a file-name sending unit operable to send a predetermined file name when a request for a file name is received from said network management apparatus;
a communication-side setting information sending unit operable to send said at least one of said program and said setting information in said communication controlling memory of said network communication apparatus to said network management apparatus, when said sent file name is specified in said network management apparatus to request a file having said file name.

27. A computer network system as claimed in claim 26, wherein said communication controlling memory is a register provided in a communication LSI for controlling said communication.

28. A computer network system as claimed in claim 26, wherein said communication controlling memory stores said setting information in the form of a table.

29. A computer network system as claimed in claim 27, wherein said communication-side setting information sending unit reads said setting information from said communication controlling memory and sends said read setting information that has been formatted by insertion of at least a code for line feed.

30. A computer network system as claimed in claim 29, wherein said communication-side setting information sending unit sends said setting information after converting said setting information into text data.

31. A computer network system as claimed in claim 26, wherein said network communication apparatus further includes a text memory operable to store text data specifying a type of contents of said setting information so as to correspond to said setting information, and
said communication-side setting information sending unit sends said network management apparatus said text data and said setting information respectively read from said text memory and said communication controlling memory, when said file is requested.

32. A computer network system as claimed in claim 26, wherein said file-name sending unit sends said file name when a LIST command or an NLST command in the FTP (File Transfer Protocol) is received from said network management apparatus.

33. A computer network system as claimed in claim 26, wherein said communication-side setting information sends said setting information when a GET command or an RETR command in the FTP (File Transfer Protocol) is received from said network management apparatus.

34. A computer network system as claimed in claim 26, wherein said network communication apparatus further includes:
a communication-side setting information receiving unit operable to receive contents of a file having a file name specified; and
a setting information updating unit operable to change said setting information stored in said communication controlling memory based on said contents of said file received by said communication-side setting information receiving unit.

35. A computer network system as claimed in claim 34, wherein said setting information updating unit changes said setting information stored in said communication controlling memory when said file name of said file received by said communication-side setting information receiving unit coincides with said file name sent by said file-name sending unit.

36. A computer network system as claimed in claim 35, wherein said setting information updating unit changes said setting information stored in said communication controlling memory when a PUT command or a STOR command in the FTP (File Transfer Protocol) is received from said network management apparatus.

37. A computer network system as claimed in claim 26, wherein said network management apparatus includes:
a file-name receiving unit operable to receive a file name determined in advance in said network communication apparatus from said network communication apparatus by specifying said network communication apparatus;
a management-side setting information receiving unit operable to receive said setting information of said network communication apparatus from said network communication apparatus by specifying said received file name; and
a display unit operable to display said received setting information.

38. A computer network system as claimed in claim 37, wherein said management-side setting information receiving unit formats said received setting information by inserting at least a code for line feed into said setting information, and
said display unit displays said formatted setting information.

39. A computer network system as claimed in claim 38, wherein said management-side setting information receiving unit converts said received setting information into text data, and
said display unit displays said setting information after being converted into said text data.

40. A computer network system as claimed in claim 37, wherein said network management apparatus further includes a text memory operable to store text data specifying a type of contents of said setting information to correspond to said setting information, and
said display unit displays said text data read from said text memory and said setting information received by said management-side setting information receiving unit in such a manner that said text data corresponds to said setting information.

41. A computer network system as claimed in claim 37, wherein said network management apparatus further includes:
a management-side setting information changing unit operable to change said received setting information; and
a management-side setting information sending unit operable to send said network communication apparatus said setting information that has been changed so as to change setting information of said network communication apparatus.

42. A computer network system as claimed in claim 37, wherein said management-side setting information sending unit sends said setting information received from said network communication apparatus to a further network communication apparatus to sent setting information of said further network communication apparatus.
